(19) United States
(12) Patent Application Publication
(10) Pub. No.: US 2004/0086434 A1
(43) Pub. Date: May 6, 2004

(54) Apparatus and method for treating objects with radicals generated from plasma

(76) Inventors: Pradad N. Gadgil, Santa Clara, CA (US); Shmuel Erez, San Jose, CA (US)

Correspondence Address: Prasad Gadgil, 301 Rosemont Drive, Santa Clara, CA, 95051, US

(21) Appl. No.: 10/288,345

(22) Filed: Nov. 4, 2002

(51) Int. Cl. B01J 19/08

(52) U.S. Cl. 422/186.04; 422/186.21

(57) ABSTRACT

The present invention provides an apparatus and method for downstream reactive radical generation from non-condensable gas plasma and its downstream interaction with a variety of chemical precursors for thin film processing. Plasma may be generated by either RF or microwave power source or a high energy UV light source may be suitably employed to ionize the non-condensable gas. Highly energetic ions and electrons are filtered from the plasma of a non-condensable gas through an in-line ion filter. The resultant radical rich flow is mixed with downstream flow of a reactive gas that may be condensable. The upstream non-condensable gas flow, plasma power and the downstream reactive gas flow all can be pulsed synchronously or all maintained constant or some of these factors may be varied in magnitude with respect to time. Thus, a variety of combinations of operational parameters of the radical generator can be practiced. Thus, either a constant or time variant flow of highly reactive radicals with well defined chemical configuration and predictable reaction pathways is obtained that can be injected on the substrate surface mounted underneath to achieve low temperature, high rate and ion-damage free processing.

### FIELD OF THE INVENTION

The present invention relates to the apparatus and method for treating objects with highly reactive radical species of a variety of gases in the gas phase downstream of plasma or an appropriate excitation source. Reactive radicals can be employed to affect desired reactions for fabrication of electronic devices at lower substrate temperatures and may be used in similar applications.

### BACKGROUND OF THE INVENTION

Manufacturing of advanced integrated circuits (ICs) in the microelectronic industry is accomplished through numerous and repetitive steps of deposition, patterning, and etching of thin films on the surface of silicon wafers. An extremely complex, monolithic and three-dimensional structure with complex topography of variety of thin film materials such as semiconductors, insulators and metals is generated on the surface of a silicon wafer in a precisely controlled manner.

The present trend in the ICs, which is going to continue in the foreseeable future, is to increase the wafer size and decrease the individual device dimensions. As an example, the silicon wafer size has progressed in recent years from 150 mm to 200 mm and now to 300 mm, and the next wafer size of 400 mm is being planned. Simultaneously, the critical device dimension has decreased from 0.25 micron to 0.18 micron, and even to 0.13 micron. Research and development for the next generation devices at 0.10 and 0.07-micron critical dimensions is being conducted by several leading IC manufacturers. This in turn translates into extremely precise control of the critical process parameters such as film thickness, morphology, and conformal step coverage over complex topography and uniformity over an increasingly large area wafer surface.

Processes of deposition and etching involve chemical reactions in which solid material is either added or removed from the substrate, and the activation energy required to affect the desired chemical reactions in a controlled fashion, is supplied by various means such as heat, light or electromagnetic excitation as applied to the gas phase or to the substrate or both, and the processes are commonly known as thermal, optical or plasma processes, respectively.

A typical chemical reaction involves breaking of chemical bonds within the reactant molecules and forming new bonds among the fragments to obtain desired products. The magnitude of the activation energy required to fragment the reactants thus determines not only the kinetics of chemical reaction and the most important operational parameter, the temperature of the substrate. Since the complex device structures involve sub-micron scale critical dimensions, the inter-diffusion and chemical reactivity of constituent elements from adjoining layers are extremely detrimental phenomena that must be minimized and in an ideal situation eliminated, the magnitude of which is described by a well-known diffusion equation: L=(D×t)1/2. Here D is diffusion co-efficient of a species in contact with a medium and t is time of activation and L is the depth to which a particular species can diffuse in to the adjoining medium. Diffusion co-efficient is strongly dependant on the temperature. Moreover, physical stability of several materials is dependant on temperature. Hence, every effort is made to either lower the reaction temperature or process time or both (thermal budget) to maintain sharp boundaries between the two adjacent layers. It is for these reasons thermal energy is supplemented either by UV light of appropriate frequency or electromagnetic excitation to affect the desired chemical reactions. Of the two, electromagnetic excitation of gas phase or plasma, as is commonly known, is the most commonly employed form of energy supplement in the thin film processing industry and more so in silicon semiconductor processing.

Plasma is conveniently generated by applying a time varying electromagnetic field to the gaseous medium, which generates high-energy electrons that collide inelastically with gas molecules and lead to their ionization and fragmentation in multiple ways. Plasma generates variety of species among others such as ions, neutral but reactive radicals with an unpaired electron, electronically activated neutrals e.g. metastables with long life times. However, in plasma a polyatomic molecule dissociates in multiple ways and forms numerous species through an extremely complex phenomenon, which is rather poorly understood. Also, chemical reactions of such fragmented species among themselves in the gas phase and with the substrate are rather poorly defined. Moreover, impact of high-energy ions with a substrate, on which a large number of electronic devices are being fabricated, can cause severe electrical damage and contribute to their failure. Hence, it is highly desirable to eliminate highly energetic ions and electrons from the plasma and use the other energetic species with definite energy quanta to affect desired chemical reactions in a controlled manner.

An inert molecule, with its completed outer shell of electrons, cannot form a radical but only an ion or an electronically excited metastable in the plasma. In the text hereafter, for example, the metastable helium is denoted as He*. The metastables can also be used to affect desired chemical reactions through energy transfer. These species also limit the number of potential reaction pathways and lend higher degree of process control. For example metastable helium can have lifetimes of several milliseconds and energy as much as 20 eV. Collision of metastable helium with ground state neutrals can lead to their excitation and or ionization which are well known as Penning and dissociative excitation processes respectively, and are described in any standard monograph related to plasma processing for example: Handbook of Plasma Processing Technology, S. M. Rossnagel, J. J. Cuomo and W. D. Westwood (editors), Noyes Publications, Westwood, N.J., 1990. Various processes for energy transfer between a neutral molecule B−X with He* are described as follows:

He*+B−X→.B+.X+He (Dissociation)

He*+B−X→BX⁺+He+e⁻ (Penning ionization)

Thus one of the modes of activation of a stable, ground state chemical precursor molecule is through a metastable helium by energy transfer mechanism as described by G. N. Parsons, D. V. Tsu and G. J. Lucovsky in a paper published in J. Vac. Sci. Technol., A6, p. 1912 (1988).

Chemically the most reactive species with a well defined quanta of energy and hence the most desirable one that can be extracted and used from plasma are radicals that participate in the chemical processes in predictable ways. A radical is formed by “homolytic” fission of a chemical bond between two atoms or two species (A..B) in which an electron pair that forms a chemical bond is equally split. A radical thus carries an unpaired electron (a dangling bond) and is an extremely reactive and electrically neutral entity. In case of diatomic gases such as H₂, direct electron impact dissociation of hydrogen in the plasma leads to a variety of species such as hydrogen ion H⁺, excited atomic hydrogen H*, excited molecular hydrogen H₂*, atomic H, and secondary electrons e⁻. For a diatomic molecule such as H₂ that dissociates in to two equal fragments, a radical and atom have exactly same electronic configuration and a radical of hydrogen is denoted hereafter as [H]. In case of a polyatomic molecule such as CH₄, dissociation of H—CH₃ bond forms methyl radical denoted by the symbol .CH₃ In general a radical of a polyatomic chemical species A, is hereafter denoted as .A.

M. J. Kushner in Journal of Applied Physics, vol. 63, p.2532 (1988) studied interactions of silane (SiH₄) with a variety of species in H₂ plasma in terms of reaction probabilities in which it was found that atomic hydrogen with well-defined energy quanta could generate .SiH₃ radicals. At the basis of radical generation process is relative bond strength or energy (expressed in kJ/mole) between the bonds within a stable molecule and the product that is formed by a reaction between a radical and such a molecule. If the latter is higher then a radical of a non-condensable gas will react with a stable molecule. It can be summarized as a reaction between an atom of a non-condensable gas .A and a stable molecule B−X (condensable or non-condensable) by the equation:

.A+B−X→A−X+.B

This reaction is feasible if the bond energies are A−X>B−X. It generates a single new product radical .B that is chemically well defined with predictable chemical behavior. Relative energies of various chemical bonds are as listed in the table below:

TABLE
Average Thermochemical Bond Energies at 25° C. in kJ/mole

| | Single Bond Energies | | | | | | | | | | | | | |
|---|---|---|---|---|---|---|---|---|---|---|---|---|---|---|
| | H | C | Si | Ge | N | P | As | O | S | Se | F | Cl | Br | I |
| H | 436 | 416 | 323 | 289 | 391 | 322 | 247 | 467 | 341 | 276 | 566 | 431 | 366 | 299 |
| C | | 356 | 301 | 255 | 285 | 264 | 201 | 336 | 272 | 243 | 485 | 327 | 285 | 213 |
| Si | | | 226 | | 335 | | | 368 | 226 | 183 | 582 | 391 | 310 | 234 |
| Ge | | | | 188 | 256 | | | 381 | | | | 342 | 276 | 213 |
| N | | | | | 160 | 200 | | 201 | | | 272 | 193 | | |
| P | | | | | | 209 | | 340 | | | 490 | 319 | 264 | 184 |
| As | | | | | | | 180 | 331 | | | 464 | 317 | 243 | 180 |
| O | | | | | | | | 146 | | | 190 | 205 | | 201 |
| S | | | | | | | | | 226 | | 326 | 255 | 213 | |
| Se | | | | | | | | | | 172 | 285 | 243 | | |
| F | | | | | | | | | | | 158 | 255 | 238 | |
| Cl | | | | | | | | | | | | 242 | 217 | 209 |
| Br | | | | | | | | | | | | | 193 | 180 |
| I | | | | | | | | | | | | | | 151 |

Double and Triple Bond Energies (“=” indicates triple bond)

| C═C | C═N | O═O | N═N | C “=” C | C “=” O | N “=” N |
|---|---|---|---|---|---|---|
| 598 | 616 | 496 | 418 | 813 | 1073 | 946 |

Thus, in summary, metastables of inert gases and atomic species or radicals of non-condensable gases can be suitably employed to generate reactive radicals of the desired species downstream. However, due to their high reactivity, radical yield from plasma is strongly dependent on the surface recombination and a strong surface catalytic effect is frequently observed. Moreover, lifetime of radicals and also metastables is also another crucial factor that must be carefully weighed in while considering their use to carry out desired reactions. Strong surface recombination and/or longer path lengths are detrimental to the viability of a radical to traverse to the substrate surface through the gas phase from the point of origin. Such factors are crucially important in order to effectively employ radicals to the advantage and special care is required to realize practical benefits of their reactivity.

As described in U.S. Pat. No. 6,083,363 issued in 2000 to K. Ashtiani, et al, a grounded grid filters ions and electrons, so as to let radicals flow downstream and away from the plasma. A chemical precursor is mixed with the radicals, and a thin film is deposited on the substrate underneath. In yet another mode, radicals are employed to activate a reactant in a well-known technique of Remote Plasma Enhanced Chemical Vapor Deposition (RPE-CVD) process. In such a configuration, plasma is generated far away from the chemical precursor injection ports, where the ion and electron concentration drops significantly by gas phase recombination. For details, please refer to G. Lukovsky, D. V. Tsu and R. J. Markunas, chapter 16, of the Handbook of Plasma Processing Technology referred above. Interaction of radicals with chemical precursors offers tremendous benefits to the vapor phase processing in improved control, less ion bombardment and ion damage and superior quality product.

Subject to satisfying such constraints, the most significant advantages of radical-assisted chemical reactions are significant lowering of the activation energy due to their high reactivity that in practical terms leads to lowering of reaction temperature and their electrical neutrality that results in to non-directional (isotropic) chemical processing along with minimal electrical/ion damage to the substrate.

T. L. Hukka et al., Mat. Res. Soc. Symp. Proc., vol. 282, p. 671 (1993) no month, published their paper describing low-pressure diamond growth using a secondary radical source. Pulsing flows of CHCl₃/CH₄ and H₂ were mixed with a constant flow of thermally generated fluorine atoms to obtain alternate pulses of .CCl₃/.CH₃ and [H] in a collision free flow to the surface such that the surface terminated with hydrogen atoms at the end of each ALD cycle. This is the first and original account of a radical-assisted ALD that the inventors know of. This process requires high-temperatures to generate fluorine atoms, and flow in the apparatus is a free flow, which leads to low rate of deposition.

Later, Fujiwara et al, published synthesis of ZnₓSe₁₋ₓ in J. Appl. Phys., vol. 74, p. 5510, November 1993, by employing atomic hydrogen generated through RF plasma and a metallic mesh ion filter. Also, S. M. Bedair published Atomic Layer Deposition process of silicon using dichlorosilane (SiH₂Cl₂) with atomic hydrogen [H] generated by hot-filament method in J. Vac. Sci. Technol., B 12(1), p. 179 (1994) dropping the deposition temperature from 900° C. to 650° C. in which the surface terminated with hydrogen at the end of pulse sequence. In these processes, a hot tungsten filament that is used to generate hydrogen radicals, and a metallic mesh to filter ions can lead to undesirable issues such as contamination and decrease in reliability of operation.

Aucoin et al in the U.S. Pat. No. 5,443,647 described an apparatus and method for plasma chemical vapor deposition. In their apparatus, which has a pulsed plasma source, a liner injector in a large volume chamber pulses chemical precursors in active plasma. All the plasma-generated species diffuse towards the substrate placed downstream on a rotating pedestal. Almost all the ions are eliminated by gas phase recombination above the substrate surface and only radicals and activated species impinge the substrate thereby allowing atomic layer growth. However, in this invention, direct injection of chemical precursors in the active plasma dissociates or fragments the chemical precursor molecules in many ways than one. The high-energy electrons in the plasma with varying kinetic energies lead to multiple pathways dissociation of the reactive gas molecules. As a result, a clearly defined mode of reaction sequence by radicals alone is eliminated. Moreover, the large reactor volume leads to the diffusive flow of the ions, radicals and excited species towards the substrate mounted downstream at a distance. All such factors slow the deposition process significantly.

Recently, Sherman in U.S. Pat. No. 5,916,365 and U.S. Pat. No. 6,342,277 has described an apparatus and method for sequential chemical vapor deposition method employing radicals of gases such as hydrogen and oxygen over substrates in a longitudinal and free flow on a stationary substrate. The reactor configuration as described in these inventions involves closing the downstream throttle valve to backfill the chamber for surface saturation and opening it to purge. In the process cycle, chemical precursor and radicals are sequenced and chemical reactions are carried out without heating the substrate. The apparatus and process described in these prior art, radicals and chemical precursors are not mixed in the gas phase prior to their impingement on to the substrate but are sequenced. The radical transport to the substrate surface by diffusion is slow and inefficient and can lead to significant recombinative losses.

Yet another invention by Sneh in the U.S. Pat. No. 6,200,893 describes the apparatus and process sequence to achieve a variety of radical-assisted chemistries to deposit thin films of metals, oxides and nitrides thereof are described. In the invention, chemical precursors and radicals are sequentially injected from a common gas distributor such as a showerhead on a stationary substrate. In a showerhead, active chemical precursor and radicals share the same flow path and although time sequenced, involve both longer path length and significant radical-surface contact. Also, any adsorption of chemical precursor on the inner surfaces of the showerhead can be highly detrimental to survival of free radicals such as [H], [O] and .NH etc. as described before. Moreover, in this invention the chemical processes employ radicals and chemical precursors sequentially but not together and are limited to reduction of a metal precursor to metal state and subsequent conversion to metal —OH or metal —NH group. Moreover, this particular invention places constraints on the gases that can be employed to generate radicals. For example, gases that can decompose and lead to a solid residue such as silane (SiH₄), germane (GeH₄), methane (CH₄), diborane (B₂H₆), phosphine (PH₃), arsine (AsH₃), hydrogen sulfide (H₂S), hydrogen selenide (H₂Se) and many others cannot be practically introduced into the plasma cavity directly to obtain desired and reactive radical species.

In yet another invention, radicals generated by the interaction of [H] and NF₃ can be effectively employed in downstream mode to etch silicon dioxide at or near room temperature as shown by Kikuchi—U.S. Pat. No. 5,620,559 and Fujimura et al., in the U.S. Pat. No. 6,107,215. Fluorine radicals generated in such an arrangement do not etch the surfaces of contact upstream, unless NF₃ is injected directly into the plasma cavity. However, this method uses long path length for ion-electron recombination ahead of the active plasma region and also a long mixing length for the reaction of the downstream chemical precursor with reactive radicals that are detrimental to radical concentration downstream. Moreover, this method of downstream reactive radical generation also does not offer independent pressure control of the downstream pressure and flow.

Related to our invention, herein, gases or vapors are defined according to their mode of interaction with plasma or a high-energy electromagnetic excitation. A non-condensable gas or a vapor is defined as a gas or a vapor that does not decompose in to one or more a gaseous components and a solid residue and/or it is a gas or vapor that does not react vigorously and destructively with the material of construction of the plasma cavity or enclosure when exposed to an external excitation such as plasma or high-energy electromagnetic radiation. Examples of non-condensable gases are, but not limited to: hydrogen, helium, argon, xenon, oxygen, nitrogen etc. Condensable gases or vapors are the ones that obviously do not satisfy the criteria described above. Examples of condensable gases are, but not limited to: hydrogen sulfide, hydrogen selenide, arsine, phosphine, silane, diborane, tungsten hexafluoride, hydrogen chloride, carbon tetra-fluoride, nitrogen tri-fluoride, CFCs, and chlorine etc.

What is clearly needed is an apparatus and method and that can efficiently produce radicals that are well defined in chemical composition from a variety of chemical species, condensable and non-condensable and a mixture thereof, in the gas phase at sufficiently high concentration to realize wide range of chemistries in the smallest volume and by employing the shortest path length.

Moreover, such an apparatus must be able to maintain radical-surface recombination to a minimum level and has the shortest path length and residence time for reactive entities from their point of origin to the substrate in the processing volume. Hence surfaces of contact with low recombination velocity in the flow path for reactive radicals must be provided to maximize their yield on the substrate.

### SUMMARY OF THE INVENTION

It is an object of the present invention to provide an apparatus and method for generation of radicals of a variety of chemical species from condensable and/or non-condensable gases with independent control of operating pressure and flow with sufficiently high concentration and with high degree of reproducibility and repeatability. It another object of the invention to generate radicals of desired chemical species through the reactive atoms of non-condensable gases with the reactive precursor molecules in the gas phase in the smallest volume and with the shortest path length thus minimizing the residence time of gas within the apparatus so as to minimize radical recombination on the inner surfaces of the apparatus. It is yet another object of the invention to define the boundary of the active plasma region to help extract only reactive intermediates such as radicals without undesirable highly energetic ions and electrons. It is also an object of an invention to provide appropriate internal surfaces of contact to minimize radical-surface recombination.

The present invention provides an apparatus and method for down-stream radical generation by employing a source of electromagnetic excitation such as plasma source (RF or microwave) that can be pulsed to generate radicals from plasma. Although an RF or microwave plasma source can be employed to generate radicals, any other source e.g. ultraviolet radiation source or thermal energy source may also be equally effective to ionize the gas. One of the plasma sources may be a compact source as described by the inventors Smith et al., in the U.S. Pat. No. 6,388,226. Stienhardt et al described another suitable source of the reactive radicals generated by plasma in the U.S. Pat. No. 5,489,362. In the present invention, a non-condensable gas source is connected to a cavity through an injection port and a switching valve. A plasma source defines an active plasma region within the cavity is provided. The exit port of the plasma cavity is connected to an ion filter that selectively removes electrically charged species from the plasma. A radial-molecule exchanger (RME) cavity is connected to the exit port of the ion filter to which an injection port is provided to inject non-condensable or condensable gas or mixtures thereof downstream in to the upstream gas flow. The injection port is connected to a switching valve, which is in turn connected to a gas source or a series of different gas sources that are either condensable or non-condensable in nature. The RME cavity below the ion filter and ahead of the down-stream reactive gas injection port forms radical-molecule exchanger. The reactive radical flow from the radical-molecule exchanger is supplied to a reactor in which a substrate is mounted on a pedestal for processing. An exit port is provided to the reactor, preferably below the pedestal that is connected to a vacuum pump through a gate valve and a throttle valve.

During the operation of the apparatus, the upstream gas-switching valve is opened and a non-condensable gas flow is established through the plasma cavity. Next, power is supplied to the plasma source and plasma is ignited within the plasma cavity. The ion filter filters out highly energized ions. Subsequently, the downstream reactive gas supply valve is opened and a reactive, condensable or non-condensable gas is injected in to the upstream flow that is highly enriched of the radicals of the non-condensable gas supplied to the plasma source. The ensuing chemical reaction of radicals generated from the plasma source with the reactive gas molecules injected downstream generates desired reactive radicals that are supplied to the reactor to process the substrate mounted within it. A constant flow of a non-condensable gas is maintained through the plasma cavity along with a constant plasma power (CW mode), and a constant reactive gas flow is maintained.

A finite time delay is involved in stabilizing the non-condensable gas flow through the plasma region by opening the upstream flow control valve, plasma power to peak and stabilize, and radicals flow to reach downstream to the RME cavity. All these system operational parameters, which depend upon the latency of valves, residence time of gas in the tube and the plasma source capability, must be carefully optimized and properly sequenced. It is stressed here that the references to the valve positions and flow in the text, e.g. upstream and downstream, are in the sense of direction of the flow only and do not imply in any way the geometrical orientation of the apparatus.

In the other embodiment of this invention, a non-condensable gas flow to the plasma cavity is pulsed in conjunction with the power supply to the plasma source such that latency in flow stabilization and onset of plasma power are synchronized. Also, the downstream reactive gas injection is in-turn phased such that the non-condensable radicals and reactive gas is mixed to achieve desired chemical reaction in the radical-molecule-exchanger, RME.

In another mode of operation of the apparatus, a non-condensable gas flow is maintained constant and the plasma power and the downstream reactive gas flow is pulsed in sync. In yet another mode of operation of the apparatus, the non-condensable gas flow is maintained constant and the plasma power is maintained at constant value and the flow of downstream reactive gas is pulsed. Furthermore, the within the plasma ON time duration of the plasma pulse, the plasma power can be rapidly pulsed multiple times.

### BRIEF DESCRIPTION OF THE DRAWINGS

FIG. 1 is a schematic view of the apparatus of the invention with the radical generator attached to a reactor.

FIGS. 2(a), (b) and (c) are the graphs of relative onset times and pulse widths of a non-condensable gas pulse, plasma pulse and the downstream reactive gas pulse in one radical generation cycle of the apparatus of the invention.

FIGS. 3(a), (b) and (c) are the graphs, similar to those of FIG. 2, of relative onset times and pulse widths of a downstream reactive gas and plasma power at constant non-condensable gas flow in one radical generation cycle of the apparatus of the invention. flow stabilization and onset of plasma power are synchronized. Also, the downstream reactive gas injection is in-turn phased such that the non-condensable radicals and reactive gas is mixed to achieve desired chemical reaction in the radical-molecule-exchanger, RME.

In another mode of operation of the apparatus, a non-condensable gas flow is maintained constant and the plasma power and the downstream reactive gas flow is pulsed in sync. In yet another mode of operation of the apparatus, the non-condensable gas flow is maintained constant and the plasma power is maintained at constant value and the flow of downstream reactive gas is pulsed. Furthermore, the within the plasma ON time duration of the plasma pulse, the plasma power can be rapidly pulsed multiple times.

### DETAILED DESCRIPTION OF THE INVENTION

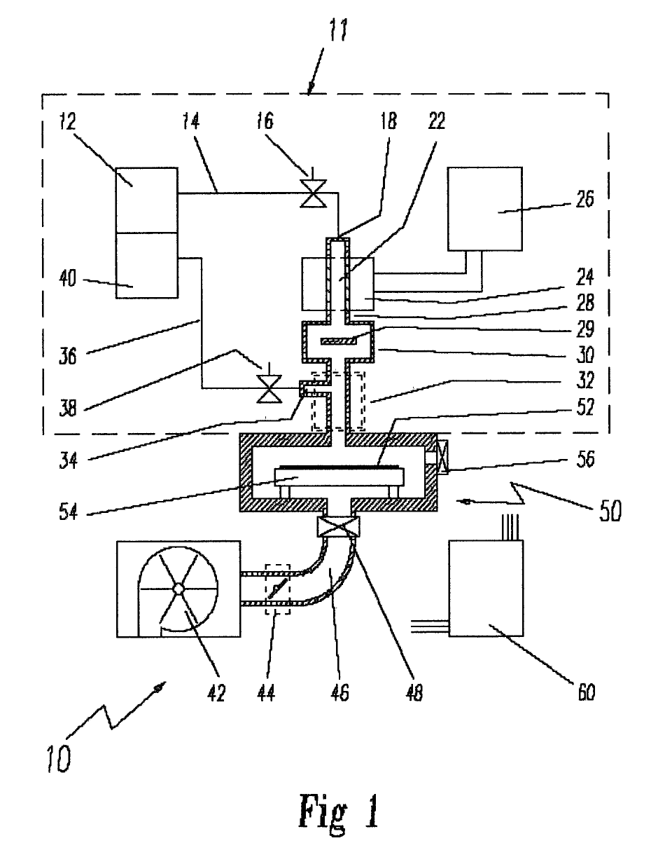

FIG. 1 is a schematic view of the apparatus of the invention with radical generator attached to a reactor in accordance with the embodiment of the present invention. The apparatus of the present invention, which in general is designated by reference numeral 10 is provided by a radical generator system 11, operated preferably at low pressure, e.g. from several tens of mTorr to several Torr, connected to a reactor 50. A non-condensable gas source 12 is connected with a suitable piping 14 to the plasma cavity 22 through a valve 16 to an inlet port 18 that feeds the gas in to the cavity 22 residing within a plasma generator 24 connected to a power supply 26. The outlet of the plasma cavity is connected through a suitable connector 28 to an ion filter 30 that comprises of a baffle plate 29. The outlet of the ion-filter 30 is connected to a radical-molecule exchanger 32. The radical-molecule exchanger 32 is provided with an injector port 34 that is connected to the downstream reactive gas source 40 through a suitable piping 36 and valve 38.

The gas flow from the radical generator system 11 is fed into the reactor 50 that is connected to a vacuum pump 42 by a vacuum line 46. The vacuum line 46 to the pump 42 is provided with a gate valve 48. Pressure in the reactor 50 is controlled by a throttle valve 44. A control system 60 controls the switching of valves 16 and 38 and plasma power supply 26, vacuum pump 42, throttle valve 44, gate valve 48 and a load-unload port 56 among other system operating parameters. A substrate 52 to be treated is placed on a pedestal such as a platen 54, which has an optional arrangement for temperature control. Substrate loading and unloading is facilitated through port 56.

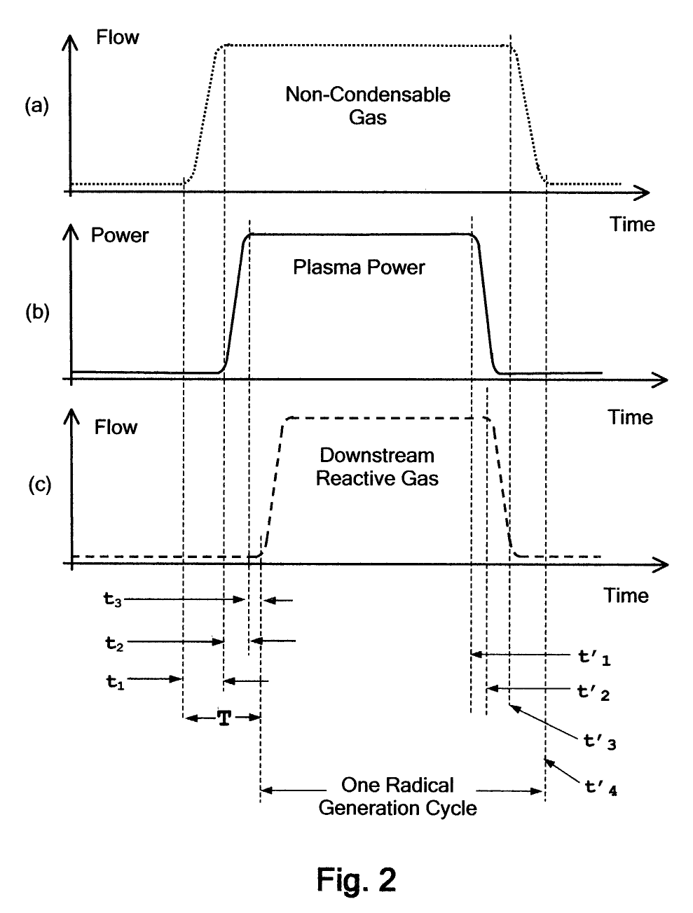

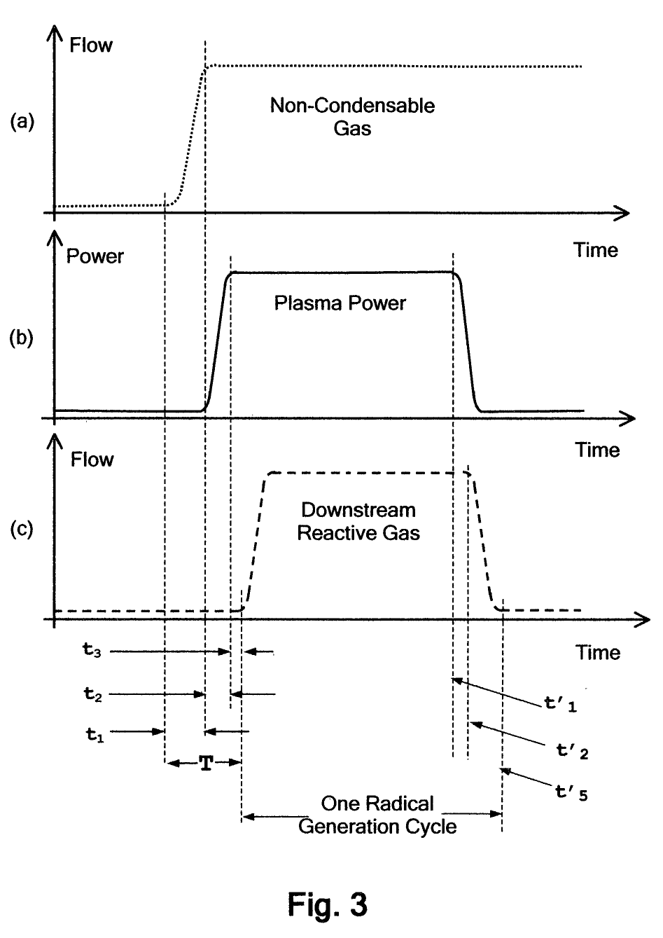

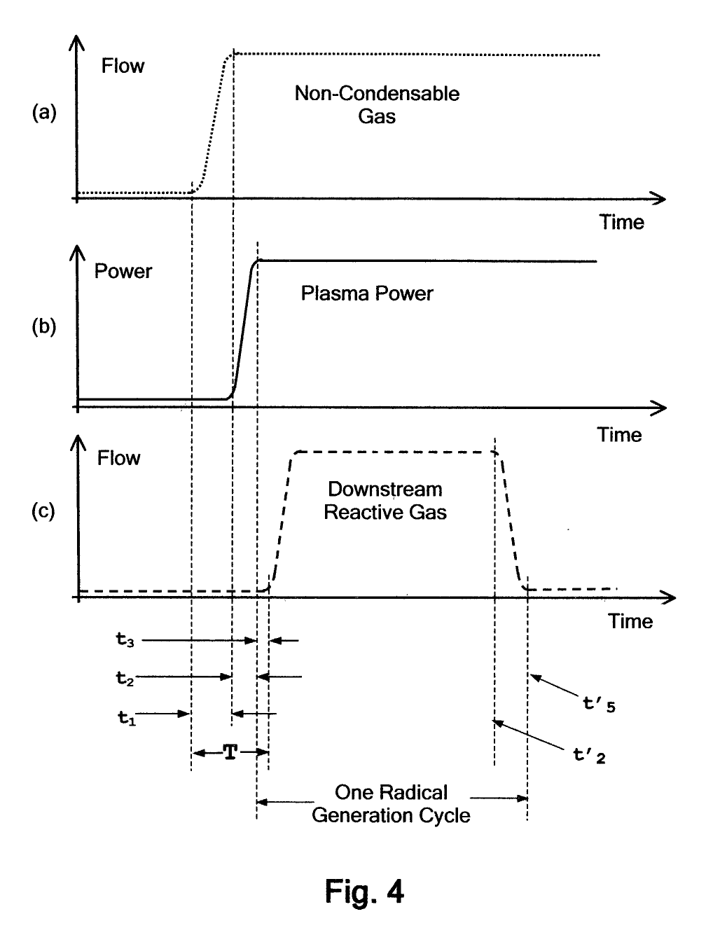

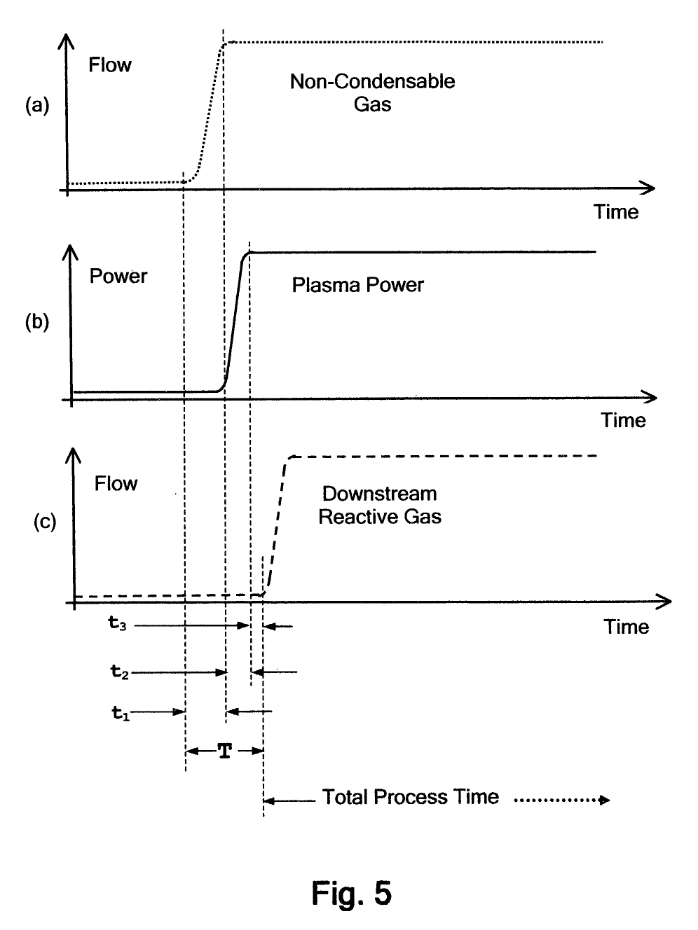

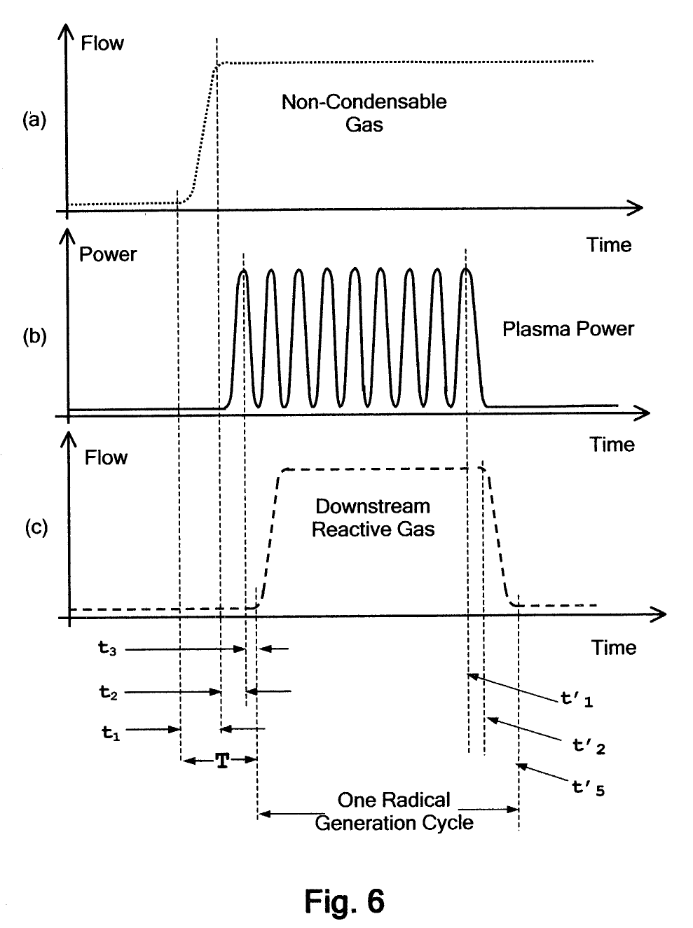

FIGS. 2(a), (b) and (c) are graphs illustrating a radical generation cycle in which a non-condensable gas is injected through port 18 by opening the control valve 16. Time t₁, plotted on the abscissa axis illustrates the gas stabilization time within the plasma cavity 22. Here and hereinafter in FIGS. 3-5, the ordinate axis of (a) shows the flow of the non-condensable gas, the ordinate axis of (b) shows the plasma power magnitude and ordinate axis of (c) shows the flow of reactive downstream gas. Referring back to FIGS. 2(a) (b) and (c), the plasma power supply 26 is switched on whereby time t₂ is required to stabilize the plasma. Next, the reactive gas is injected through port 34 by opening the valve 38 for which t₃ is a compensation for the flow latency. The sum total of the delays T=t₁+t₂+t₃.

Again referring to FIGS. 2(a), (b) and (c) at time t′₁ from the onset the plasma power 26 is switched off. At time t′₂ from the onset, the downstream reactive gas flow is switched off by closing valve 38. Next, valve 18 is switched off at time t′₃ from the onset to switch off the flow of a non-condensable gas to cavity 22. The time t′₄ signifies the completion time for one radical generation cycle. The cycle can be repeated desired number of times in order to achieve desired process result on the substrate 52 in the reactor 50.

FIGS. 3(b) and (c) show relative onset times and pulse widths of a downstream reactive gas and plasma power respectively, at constant non-condensable gas flow as shown in FIG. 3(a) in one radical generation cycle of the apparatus of the invention. The time t′₅ signifies the completion time for one radical generation cycle. The cycle can be repeated desired number of times in order to achieve desired process result on the substrate 52 in the reactor 50.

FIGS. 4(a) and (b) indicate relative onset times of the flow of a non-condensable gas and plasma power respectively. FIG. 4(c) indicates the relative onset time of a pulse of downstream reactive gas in one radical generation cycle. The time t′₅ signifies the completion time for one radical generation cycle. The cycle can be repeated desired number of times in order to achieve desired process result on the substrate 52 in the reactor 50.

FIGS. 5(a), (b) and (c) illustrates relative onset times of the constant non-condensable gas flow and fixed plasma power and constant downstream reactive gas flow respectively, for the length of the process.

FIG. 6 illustrates rapid plasma pulsing (b) within one radical generation cycle. Rapid plasma pulsing can be combined with previously described radical generation cycles and also with the continuous flow mode of operation.

The invention will now be described by way of practical examples, which should not be construed by way of limiting the scope of the invention.

### EXAMPLE 1

### Downstream Generation of .OH Radicals

The process was carried out to generate hydroxyl radicals (.OH) downstream with the following sequential steps. Hydrogen was stored in the gas box 12 and connected by the tube 14 to the upstream valve 16. The valve 16 was opened to set up a flow of hydrogen, a non-condensable gas, in the plasma cavity 22. Subsequent to hydrogen gas flow stabilization in the plasma cavity 22, the power supply 26 was activated to supply power to plasma generator 24 to establish plasma in the plasma cavity 22. The ion filter 30 filtered ions and electrons in the plasma and a flow enriched with active hydrogen atoms [H] was established downstream at the exit port of the ion filter. Oxygen gas, also stored in the gas box 40 was supplied to the radical-molecule-exchanger cavity through piping 36 by opening the valve 38. The ensuing chemical reaction between hydrogen atoms [H] and oxygen molecules O₂, within the radical-molecule-exchanger (RME) 32 generated reactive radicals .OH that were supplied to the substrate 52 mounted on the pedestal 54 in the reactor 50. The steps described above and the relative bond energies of the relevant chemical species can be summarized as shown below:

a) Upstream non-condensable gas: H₂

b) H₂→[plasma]→H⁺, H₂⁺, [H], H*, e⁻→[ion filter]→[H]

c) 2 [H]+O₂ (downstream)→2 [.OH]

d) (O═O bond energy=496 kJ/mol, O—H bond energy=934 kJ/mol)

### EXAMPLE 2

### Downstream Generation of Silyl (.SiH₃) Radicals

The process was carried out to generate silyl radicals (.SiH₃) downstream with the following sequential steps. Hydrogen was stored in the gas box 12 and connected by the tube 14 to the upstream valve 16. The valve 16 was opened to set up a flow of hydrogen, a non-condensable gas, in the plasma cavity 22. Subsequent to hydrogen gas flow stabilization in the plasma cavity 22, the power supply 26 was activated to supply power to plasma generator 24 to establish plasma in the plasma cavity 22. The ion filter 30 filtered ions and electrons in the plasma and a flow enriched with active hydrogen atoms [H] was established downstream at the exit port of the ion filter. Silane gas (SiH₄), also stored in the gas box 40 was supplied to the radical-molecule-exchanger cavity through piping 36 by opening the valve 38. The ensuing chemical reaction between hydrogen atoms [H] and silane molecules SiH₄, within the radical-molecule-exchanger (RME) 32 generated reactive silyl radicals (.SiH₃) that were supplied to the substrate 52 mounted on the pedestal 54 in the reactor 50. The steps described above and the relative bond energies of the relevant chemical species can be summarized as shown below:

a) Upstream non-condensable gas: H₂

b) H₂→[plasma]→H⁺, H₂⁺, [H], H*, e⁻→[ion filter]→[H]

c) [H]+SiH₄ (downstream)→.SiH₃+H₂

(Si—H bond energy=323 kJ/mol, H—H bond energy=426 kJ/mol)

### EXAMPLE 3

### Downstream Generation of Silyl (.SiH₃) Radicals from Neutral, Metastable He*

The process was carried out to generate silyl radicals (.SiH₃) downstream with the following sequential steps. Helium was stored in the gas box 12 and connected by the tube 14 to the upstream valve 16. The valve 16 was opened to set up a flow of helium, a non-condensable gas, in the plasma cavity 22. Subsequent to helium gas flow stabilization in the plasma cavity 22, the power supply 26 was activated to supply power to plasma generator 24 to establish plasma in the plasma cavity 22. The ion filter 30 filtered ions and electrons in the plasma and a flow enriched with metastable helium, He* species was established downstream at the exit port of the ion filter. Silane gas (SiH₄), also stored in the gas box 40 was supplied to the radical-molecule-exchanger cavity through piping 36 by opening the valve 38. The ensuing chemical reaction between He* and silane molecules SiH₄, within the radical-molecule-exchanger (RME) 32 generated reactive silyl radicals (.SiH₃) that were supplied to the substrate 52 mounted on the pedestal 54 in the reactor 50. The steps described above and the relative bond energies of the relevant chemical species can be summarized as below:

a) Upstream non-condensable gas: He

b) He→[plasma]→He⁺, He*, e⁻→[ion filter]→He*

c) He*+SiH₄(downstream)→.SiH₃+H₂+He

(Si—H bond energy=323 kJ/mol, He*→He excitation energy=1932 kJ/mol)

A variety of other combinations of the operational parameters of the radical generator that are not listed herein are possible. However, they all fall within the scope of the invention, and can be employed to obtain the desired processes on the surface of the substrate mounted within reactor that operate either in a continuous mode or in a pulse mode. Such variations and combinations allow the practitioner to modulate the rate of processing over a wide range. In a continuous radical supply mode, the reactor operates as a Remote Plasma Enhanced (RPE) processor while, in pulsed radical supply mode the reactor operates as a radical assisted ALD reactor. Operational advantages of such an apparatus and process are high speed, lower process temperature, and substantial reduction in ion damage, efficient chemical utilization and precision processing with uniform and highly conformal surface coverage.

Although the rapid pulsing of plasma during plasma ON phase was shown in FIG. 6 only in combination with constant flow of non-condensable gas and pulsed downstream reactive gas, it is applicable to all other modes of operation, i.e. in combination with:

(i) Pulsed non-condensable gas flow and pulsed downstream reactive gas flow along with pulsed plasma mode as shown originally in FIG. 2;

(ii) Constant non-condensable gas flow, constant and continuous but rapidly pulsed plasma power and pulsed downstream reactive gas flow as shown originally in FIG. 4; and,

(iii) Constant non-condensable gas flow with constant downstream reactive gas flow with a continuous but rapidly pulsed plasma as shown originally in FIG. 5.

Moreover, different pulse widths, different amplitudes and pulse different frequencies of plasma power within plasma ON pulse width and use of different non-condensable gases, all fall within the scope of the invention. Thus, the invention has been shown and described with reference to specific embodiments, which should not be construed as the only examples and hence do not limit the scope of the applications of the invention. Therefore, any changes and modifications in technological processes, constructions, materials, shapes and their components are possible, provided these changes and modifications do not depart from the scope of the patent claims.

Within the context of the present application, the term “ion filter” not necessarily means a separate device or component that can be inserted into the flow path of the fluid, and the function of the ion filter can be accomplished, e.g., by means of an L-shaped pipe connecting the plasma source with the radical molecule exchanger. This is because the ions have a linear path and will be automatically filtered out by collision with the perpendicular branch of the pipe while the fluid with radicals will change their direction.

1. An apparatus for treating objects with radicals generated from plasma, comprising:
a plasma source for generating plasma in a flow of at least one non-condensable fluid, said plasma source having a plasma source inlet and a plasma source outlet, said plasma comprising ions, electrons, and source radicals;
a first source of at least one non-condensable fluid for generation of said flow of said at least one non-condensable fluid connected to said plasma source inlet, said first source having a first source outlet;
an ion filter having an ion filter inlet and an ion filter outlet, said ion filter inlet is connected to said plasma source outlet for receiving said plasma;
a second source of at least one reactive fluid selected from a group comparing of a condensable fluid and a non-condensable fluid, said second source having a second source outlet;
a radical molecule exchanger for generation of reactive radicals from said source radicals due to a reaction between said source radicals and said at least one reactive fluid, said radical molecule exchanger having a first exchanger inlet connected to said ion filter outlet, a second exchanger inlet connected to said second source outlet, and an exchanger outlet;
a processing chamber for processing of said objects with the use of said reactive radicals having a chamber inlet connected to said exchanger outlet and a vacuum port; and
a source for vacuum connected to said processing chamber via said vacuum port.

2. The apparatus of claim 1, wherein said at least one non-condensable fluid is a gas selected from a group of H₂, O₂, N₂, He, Ar, Xe.

3. The apparatus of claim 2, wherein said at least one reactive fluid is a gas selected from a group of SiH₄, GeH₄, CH₄, B₂H₆, PH₃, AsH₃, H₂S, H₂Se, NF₃, CF₄, CH₄, CHF₃, CH₃F, CHCl₃.

4. The apparatus of claim 1, further comprising:
a first controllable valve between said first source outlet and said plasma source inlet;
a second controllable valve between said source outlet and said second exchanger inlet; and
an electronic control unit for controlling operation at least of said a first controllable valve and of said second controllable valve.

5. The apparatus of claim 3, further comprising an object holder located in said processing chamber for holding said objects.

6. The apparatus of claim 3, further comprising:
a first controllable valve between said first source outlet and said plasma source inlet; a second controllable valve between said source outlet and said second exchanger inlet; and an electronic control unit for controlling operation at least of said a first controllable valve and of said second controllable valve.

7. The apparatus of claim 6, further comprising an object holder located in said processing chamber for holding said objects.

8. The apparatus of claim 1, further comprising a pressure control valve located between said source of vacuum and said processing chamber and controlled by said electronic control unit.

9. The apparatus of claim 4, further comprising a pressure control valve located between said source of vacuum and said processing chamber and controlled by said electronic control unit.

10. The apparatus of claim 7, further comprising a pressure control valve located between said source of vacuum and said processing chamber and controlled by said electronic control unit.

11. An apparatus for treating semiconductor substrates with radicals from plasma, comprising:
a plasma source for generating plasma in a flow of at least one non-condensable gas, said plasma source having a plasma source inlet and a plasma source outlet, said plasma comprising ions, electrons, and source radicals;
a first source of at least one non-condensable gas for generation of said flow of said at least one non-condensable gas connected to said plasma source inlet, said first source having a first source outlet;
an ion filter having an ion filter inlet and an ion filter outlet, said ion filter inlet is connected to said plasma source outlet for receiving said plasma;
a second source of at least one reactive gas selected from a group comprising a condensable gas and a non-condensable gas, said second source having a second source outlet;
a radical molecule exchanger for generation of reactive radicals from said source radicals due to a reaction between said source radicals and said at least one reactive gas, said radical molecule exchanger having a first exchanger inlet connected to said ion filter outlet, a second exchanger inlet connected to said second source outlet, and an exchanger outlet;
a processing chamber for processing of said semiconductor substrates with the use of said reactive radicals having a chamber inlet connected to said exchanger outlet and a vacuum port; and
a source for vacuum connected to said processing chamber via said vacuum port.

12. The apparatus of claim 11, wherein said at least one non-condensable gas is a gas selected from a group of H₂, O₂, N₂, He, Ar, Xe.

13. The apparatus of claim 12, wherein said at least one reactive gas is a gas selected from a group of SiH₄, GeH₄, CH₄, B₂H₆, PH₃, AsH₃, H₂S, H₂Se, NF₃, CF₄, CH₄, CHF₃, CH₃F, CHCl₃.

14. The apparatus of claim 13, further comprising:
a pressure control valve located between said source of vacuum and said processing chamber;
a first controllable valve between said first source outlet and said plasma source inlet;
a second controllable valve between said source outlet and said second exchanger inlet; a pressure control valve between said processing chamber and said source of vacuum; and an electronic control unit for controlling operation at least of said a first controllable valve, said second controllable valve, and said pressure control valve.

15. The apparatus of claim 14, further comprising an object holder located in said processing chamber for holding said objects.

16. A method of treating an object with radicals extracted from plasma comprising electrons, ions, and source radicals, said method comprising:
a) providing an apparatus comprising a source of at least one non-condensable fluid, a source of at least one reactive fluid, a plasma source with a power supply unit for applying plasma power to said plasma source, said plasma source being connected to said source of non-condensable fluid, an ion filter connected to said plasma source, a radical molecular exchanger connected to said ion filter, and a processing chamber connected to said radical molecule exchanger and to a source of vacuum;
b) placing said object into said processing chamber;
c) inducing a vacuum in said processing chamber with the use of said source of vacuum;
d) supplying said at least one non-condensable fluid from said source of a non-condensable fluid to said plasma source;
e) applying a plasma power to said plasma source thus generating said plasma;
f) filtering out said ions and said electrons by means of said ion filter from said plasma for obtaining extracted source radicals and for supplying said extracted source radicals to said radical molecule exchanger;
g) supplying said at least one reactive fluid to said radical molecule exchanger for mixing with said extracted source radicals thus forming reactive radicals;
h) supplying said reactive radicals to said processing chamber; and
i) treating said object with said reactive radicals.

17. The method of claim 16, wherein in a single cycle said steps d) precedes said steps e), and g); said step e) precedes said step g) but occurs later than said step d); and step g) occurs later than said steps e) and d).

18. The method of claim 17, wherein in said single cycle said steps d) is completed later than said steps e) and g); said step e) is completed later than said step g).

19. The method of claim 18, wherein said steps d) and g) can be performed in a mode selected from a continuous mode and a single-pulse mode, and wherein said step e) can be performed in a multiple-pulse mode.

20. The method of claim 19, wherein said single cycle is repeated until processing of said object is completed.
